(19) United States
(12) Patent Application Publication
(10) Pub. No.: US 2011/0074372 A1
(43) Pub. Date: Mar. 31, 2011

(54) Architecture of a Power Supply Circuit with Power Factor Correction

(76) Inventor: William YU, Laytonsville, MD (US)

(21) Appl. No.: 12/708,399

(22) Filed: Feb. 18, 2010

(30) Foreign Application Priority Data
Feb. 18, 2009 (CN) 200910046294.0

(51) Int. Cl. G05F 1/618

(52) U.S. Cl. 323/282

(57) ABSTRACT

An improved architecture of a power supply circuit with power factor correction, the power supply circuit includes power supply circuit output terminals and a voltage negative feedback circuit, the power supply circuit output terminals include a high potential terminals and a low potential terminals, the voltage negative feedback circuit includes a first feedback circuit and a second feedback circuit connected in series in order from the high potential terminal to the low potential terminal, a connection point of the first feedback circuit and the second feedback circuit acts as a feedback signal output terminal through which the voltage negative feedback circuit outputs a feedback signal, in the improved architecture, the first feedback circuit is replaced by a light source branch including a constant-current light source, and the second feedback circuit is replaced by a resistor branch for determining a working current of the light source branch. This improved architecture can perform a constant-current supply with high power factor and high efficiency for the light source.

### FIELD OF THE INVENTION

The present application is related to a power supply circuit of a constant-current light source, specifically, to an improved architecture of a power supply circuit with power factor correction.

### DESCRIPTION OF THE BACKGROUND ART

In the prior art, power supply circuits with power factor correction are used to supply power to various electronic, electric appliance apparatuses so as to improve the characteristic of the electrical network and achieve the object of power-saving. In order to reduce the cost and improve the convenience of the circuit design, people integrate the power correction circuit portion in this kind of power supply circuit, and produce the universal power factor correction device such as L6560, 6561, and use the said devices to construct the power supply circuit with power factor correction. This kind of power supply circuit has the advantage of high power factor, high efficiency and convenience of the circuit design. At present, normally the above power supply circuit appeared in the market is the constant-voltage power supply circuit with the voltage negative feedback. When the constant-current light source needs to be supplied by this kind of power supply circuit, the general method is designing a constant-current power supply circuit for the constant-current light source, and then employing the output of the constant-voltage power supply circuit with power factor correction as the power input of the constant-current power supply circuit. For this kind of power supply circuit of the constant-current light source formed by two-stage cascade connection, since the constant-current power supply circuit is introduced into the constant-voltage power supply circuit with power factor correction, the power factor and efficiency of the entire power supply circuit decrease.

### SUMMARY OF THE INVENTION

In order to solve the above problem, the object of the present invention is to provide an improved architecture of power supply circuit with power factor correction, which has high power factor and high efficiency.

The present invention provides an improved architecture of a power supply circuit with power factor correction, the power supply circuit includes power supply circuit output terminals and a voltage negative feedback circuit, the power supply circuit output terminals include a high potential terminal and a low potential terminal, the voltage negative feedback circuit includes a first feedback circuit and a second feedback circuit connected in series in order from the high potential terminal to the low potential terminal, a connection point between the first feedback circuit and the second feedback circuit acts as a feedback signal output terminal through which the voltage negative feedback circuit outputs a feedback signal, wherein, in the improved architecture, the first feedback circuit is replaced by a light source branch including a constant-current light source, and the second feedback circuit is replaced by a resistor branch for determining a working current of the light source.

In the improved architecture of the present invention formed according to the above manner, since the voltage feedback circuit in the original power supply circuit is reconstructed into the light source branch and the resistor branch, thus a supply of constant-current with a current negative feedback function is formed for the constant-current light source, instead of forming the power supply circuit for supplying power to the constant-current light source via the constant-voltage source and constant-current source in a cascade connection as employed in the prior art. As compared with the prior art, the present invention has the advantage of high power factor and highly efficient supply for the constant-current light source.

### BRIEF DESCRIPTION OF THE DRAWINGS

FIG. 1 is an example of the electrical principle diagram of the power supply circuit with power factor correction in the prior art.

FIG. 2 is the electrical principle diagram of the improved architecture of the power supply circuit with power factor correction according to an embodiment of the present invention.

### DESCRIPTION OF THE PREFERRED EMBODIMENTS

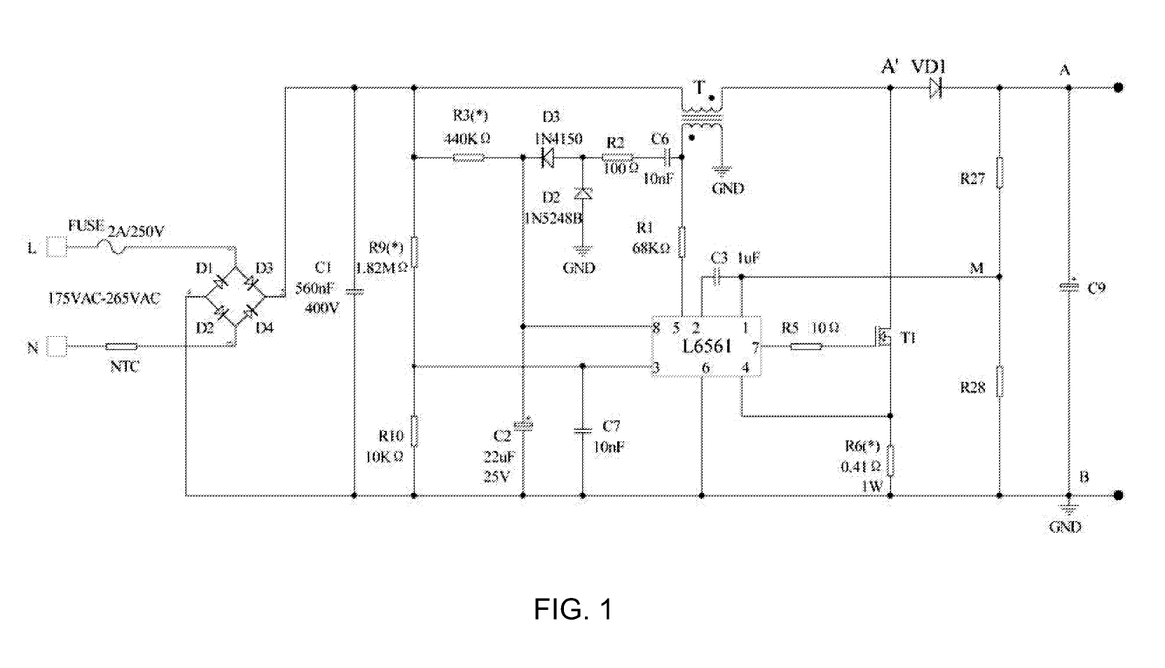

FIG. 1 illustrates an example of the electrical principle diagram of the power supply circuit with power factor correction (hereinafter, called “power supply circuit” in brief) in the prior art, This power supply circuit is a constant-voltage source having a voltage negative feedback circuit (R27, R28), with a power factor corrector of the universal component, such as L6561, as its main component. Wherein, the power factor corrector L6561 may be other types, for example, the power factor corrector of L6560, and also may be a power factor corrector formed by separated components. This type of constant-voltage source has the advantage of high power factor and highly efficient supply. This type of power supply circuit includes power supply circuit output terminals (A, B) for outputting power (voltage, current) from the output tube (drive tube) (T1) via a diode (VD1) and a voltage negative feedback circuit (R27, R28). The power supply circuit output terminals (A, B) include a high potential terminal (A) and a lower potential terminal (B). The high potential terminal (A) is a terminal by which the high potential terminal (A′) of the output tube (T) outputs the high potential via the diode (VD1). The low potential terminal (B) is the common low potential terminal of the power supply circuit, which commonly acts as the grounding terminal (it is not limited to grounding) of the power supply circuit. In the case where the power factor corrector employs the power factor corrector of a standard component, such as L6560, L6561 and so on, the low potential terminal (B) is connected to the pin 6 of the power factor corrector of the standard component. The voltage negative feedback circuit (R27, R28) includes a first feedback circuit (R27) and a second feedback circuit (R28) connected in series in an order from the high potential terminal (A) to the low potential terminal (B). The so-connected connection point between the first feedback circuit (R27) and the second feedback circuit (R28) acts as the feedback signal output terminal (M) for outputting the feedback signal. The first feedback circuit (R27) and the second feedback circuit (R28) are commonly constructed by the resistor components, however, the case of introducing other sensing components for the purpose of testing or controlling is not excluded. The load of the power supply circuit (not shown) is to be connected to the power supply circuit output terminals (A, B).

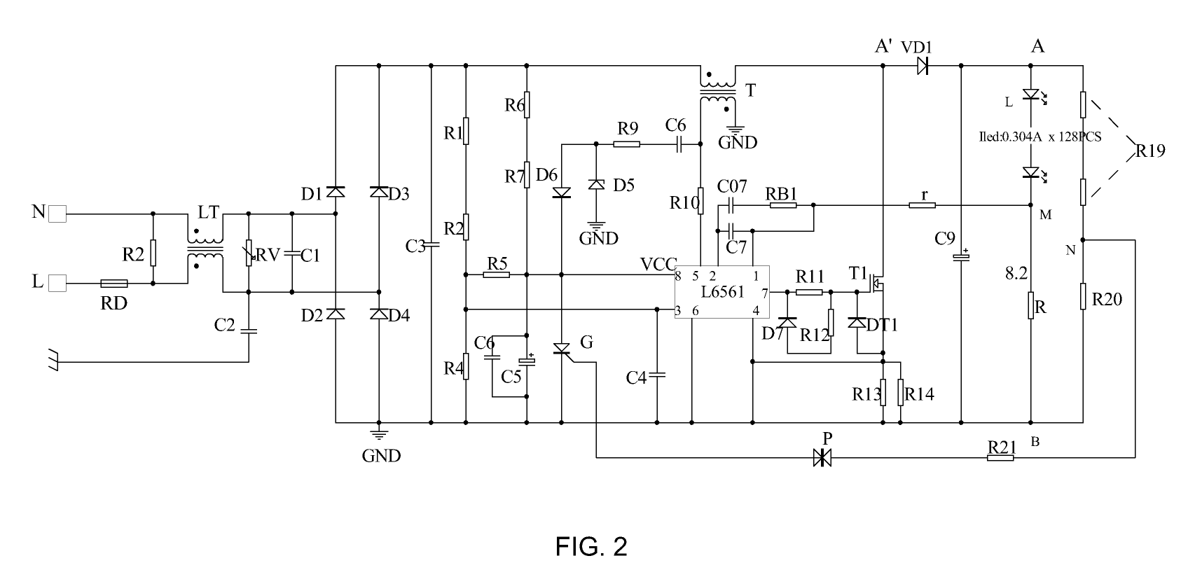

FIG. 2 is the electrical principle diagram of the improved architecture of the power supply circuit with power factor correction according to an embodiment of the present invention. Referring to FIG. 2, as compared with the above prior art as illustrated by FIG. 1, the most significant improvement lies in that, the first feedback circuit (R27) in FIG. 1 is replaced by a light source branch (L) including a constant-current light source, and the second feedback circuit (R28) is replaced by a resistor branch (R) for determining the working current of the light source branch (L). Thus, the light source branch (L) and the resistor branch (R) construct the current negative feedback circuit of the light source branch (L). It is not excluded that the so-called light source branch (L) may include the components with other functions beside the constant-current light source.

The example of the constant-current light source is a gas discharge lamp or light emitting diode (LED), etc. In the case where the constant-current light source is the gas discharge lamp, the light source branch (L) includes one gas discharge lamp. In the case where the constant-current light source is the LED, the light source branch (L) includes a plurality of LEDs connected in series. As a modification, each LED can (is not limited to) be in parallel connection with a voltage stabilizing diode whose polarity is opposite to that of LED (not shown), so that when the LED is in open circuit, a reverse breakdown conducting occurs in the voltage stabilizing diode and the illumination of the light source branch is maintained. Since the voltage stabilizing operation of the power supply circuit with power factor correction in the prior art is realized through sampling (dividing) the voltage of the output terminals (A, B) by voltage negative feedback, namely the voltage dividing circuit (the voltage negative feedback circuit (R27, R28)), controlling the grid of the output tube (T1) to cause the output tube (T1) to be in a on-and-off operation under the control of a periodical plus by the voltage obtained by performing a series of process, such as comparison and amplification to the sampled voltage and the cooperation of the voltage transformer (T), the diode (VD1) and the output capacitor (C9). And the reference voltage for the comparison is unchanged, therefore, the voltage on the both ends of the second negative feedback circuit (R28), i.e., the resistor branch (R) is substantially unchanged (also, we can say that the change after the voltage stabilizing adjustment is very small due to the existence of the amplification process), that is, is approximately equal to the said reference voltage. The present invention utilizes the characteristic of unchanged voltage on the both end of the second feedback circuit, i.e., the resistor branch (R), so that the resistance value of the resistor branch (R) can be used to determine the working current required by the fight source branch (L), that is, the resistance value of the resistor branch (R) is equal to the result of dividing the said reference voltage by the working current of the light source branch (L). The so-called working current of the light source branch (L) is the total current flowing through the light source branch (L). In the example as shown in FIG. 2, the reference voltage=2.5V, the light source branch (L) is formed by 128 LEDs, each of which requires a current of Iled=0.304 A connected in series, the resistor branch (R) is formed by a resistor R, wherein the resistance of the resistor branch (R) can be calculated to be R=8.2 ohm according to the above relationship among the above three objects. In the embodiments as shown in FIG. 2, although the light source branch (L) is formed by a plurality of LEDs connected in series and the resistor branch (R) is constructed by the resistor, the sensing components for sensing the working current of the light source branch can also be introduced into these two branches.

The improvement of the present invention further lies in that, an overvoltage-protective circuit for preventing the overvoltage from forming at the power supply circuit output terminals (A, B) when the light source branch (L) is in a open-circuit condition or the resistor branch (R) is in a short-circuit condition is provided. In a preferred embodiment, the overvoltage-protective circuit includes a voltage-dividing resistor branch (R19, R20) connected between the high potential terminal (A) and the low potential terminal (B), and a silicon-controlled rectifier (G) connected between the pin 8 of the power factor corrector and the low potential terminal (B), wherein a bidirectional trigger tube (P) and a resistor device (R21) are connected between the control grid of the silicon-controlled rectifier (G) and the voltage-dividing node of the voltage-dividing resistor branch (R19, R20). It can be seen from FIG. 2 that, once the light source branch (L) is in a open-circuit condition or the resistor branch (R) is in a short-circuit condition, the potential of the point M (feedback signal output terminal (M)) drops, resulting in decrease of the potential of the feedback signal input terminal (for example, pin 1 of L6561) for receiving the potential (feedback signal), and sharp increase of the voltage of the power supply circuit output terminals (A, B) after the voltage negative feedback adjustment, which may cause damage of the output tube (T) or the constant-current light source, for example, LED. Since the overvoltage-protective circuit is provided at the power supply circuit output terminals (A, B) in the present application, once the voltage of the power supply circuit output terminals (A, B) increases sharply, the potential of the point N (the voltage-dividing node (N)) increases along with it. When the potential of the point N increases to a first predetermined value, it can be applied to the gird of the silicon-controlled rectifier via the bidirectional trigger tube (P); and when the potential of the point N increases to a second predetermined value which is larger than the first predetermined value, it triggers the silicon-controlled rectifier to be conducted, causes the potential of the pin 8 of L6561 to be locked at a low potential (approximately zero potential), finally causes the output tube (T1) to be always in the conducted state through the control of the internal processing circuit of L6561, and causes the power supply circuit output terminals (A, B) to be in a low potential state, thus the object of the overvoltage protection is achieved.

The improvement of the present invention further includes that, an overcurrent-protective resistor (r), for preventing the overcurrent from flowing into the feedback signal input terminal (for example, the pin 1 of L6561) when the resistor branch is in an open-circuit condition, is connected in series between the feedback signal output terminal (M) and a feedback signal input terminal for receiving the feedback signal.

Further, the improvement of the present invention also includes that, a resistor (R2), a voltage transformer (LT), a resistor (RV), a capacitor (C1) and a capacitor (C2), which form a filter for restraining the high-frequency signal generated by the improved architecture of the power supply circuit with power factor correction from flowing in the electrical network (alternating current power (AC power)), are provided between the AC power (N, L) (commonly are commercial power) and the rectification circuit (D1-D4) of the power supply circuit.

The invention is described in detail in conjunction with the drawings. A person skilled in the art can make other modifications, other than the modification described in the description, according to the conception of the invention disclosed by the specification. Therefore, the embodiments and the modifications thereof described in the specification should not be treated as the limitation to the present invention. The present invention should be defined by the appended claims embodying the conception of the present invention.

1. An improved architecture of a power supply circuit with power factor correction, in which the power supply circuit includes power supply circuit output terminals and a voltage negative feedback circuit, the power supply circuit output terminals include a high potential terminal and a low potential terminal, the voltage negative feedback circuit includes a first feedback circuit and a second feedback circuit connected in series in order from a high potential terminal to a low potential terminal, and a connection point between the first feedback circuit and the second feedback circuit acts as a feedback signal output terminal through which the voltage negative feedback circuit outputs a feedback signal, characterized in that,
in the improved architecture, the first feedback circuit is replaced by a light source branch including a constant-current light source, and the second feedback circuit is replaced by a resistor branch for determining a working current of the light source branch.

2. The improved architecture as described in claim 1, characterized in that, an overvoltage-protective circuit for preventing overvoltage from forming at the power supply circuit output terminal when the light source branch is in an open-circuit condition or the resistor branch is in a short-circuit condition is provided at the power supply circuit output end.

3. The improved architecture as described in claim 1, characterized in that, an overcurrent-protective resistor for preventing overcurrent from flowing into the feedback signal input terminal when the resistor branch is in the open-circuit condition is provided between the feedback signal output terminal and a feedback signal input terminal for receiving the feedback signal.

4. The improved architecture as described in claim 1, characterized in that, the power supply circuit further includes a rectification circuit for performing rectification for an alternating current power, and a filter for restraining a high-frequency signal generated by the improved architecture of the power supply circuit with power factor correction from flowing into the alternating current power is provided between the alternating current power and the rectification circuit.

5. The improved architecture as described in claim 1, characterized in that, the light source branch includes a plurality of light emitting diodes connected in series.

6. The improved architecture as described in claim 5, characterized in that, the resistor branch is a resistor.

7. The improved architecture as described in claim 6, characterized in that, the power supply circuit includes a power factor corrector as a universal component.

8. The improved architecture as described in claim 7, characterized in that, the power factor corrector is a power factor corrector of L6560 series or L6561 series.

9. The improved architecture as described in claim 8, characterized in that, the feedback signal input terminal is pin 1 of the power factor corrector.

10. The improved architecture as described in claim 9, characterized in that, the overvoltage-protective circuit includes a voltage-dividing resistor branch connected between the high potential terminal and the low potential terminal, and a silicon-controlled rectifier connected between pin 8 of the power factor corrector and the low potential end, wherein a bidirectional trigger tube and a resistor device are connected between a control gird of the silicon-controlled rectifier and a voltage-dividing node of the voltage-dividing resistor branch.
